(19) United States
(12) Patent Application Publication
(10) Pub. No.: US 2025/0188865 A1
(43) Pub. Date: Jun. 12, 2025

(54) IMPROVED TURBOMACHINE FOR HYBRID AIRCRAFT

(71) Applicant: SAFRAN HELICOPTER ENGINES, Bordes (FR)

(72) Inventor: Benjamin Nicolas FULLERINGER, Moissy-Cramayel (FR)

(73) Assignee: SAFRAN HELICOPTER ENGINES, Bordes (FR)

(21) Appl. No.: 18/846,768

(22) PCT Filed: Mar. 7, 2023
(86) PCT No.: PCT/FR2023/050300

§ 371 Date: Sep. 13, 2024

(30) Foreign Application Priority Data
Mar. 16, 2022 (FR) 2202290

(51) Int. Cl. F02C 3/10; F02C 3/14

(52) U.S. Cl. CPC F02C 3/103; F02C 3/145; F05D 2220/323; F05D 2220/76

(57) ABSTRACT

A turbomachine for hybrid aircraft, including a gas generator carried by a generator shaft, at least one free turbine carried by a turbine shaft and driven in rotation by a gas stream generated by the gas generator, a main rotor, and at least one reversible electric machine, the turbine shaft being a through shaft and extending axially between a first end engaged with the electric machine, and a second end engaged with the main rotor.

### TECHNICAL FIELD

The present invention relates to the field of hybrid aircrafts, comprising at least one turbomachine for flying machines, such as a turboprop for an airplane or a turbine engine for a helicopter. Particularly, the invention relates to a turbomachine for a hybrid aircraft, and a hybrid aircraft comprising such a turbomachine.

### PRIOR ART

In a known manner, a turbomachine, for example a turbine engine or a turboprop, for a helicopter or for an airplane, includes a gas turbine having a gas generator and a free turbine driven in rotation by the gas stream generated by the gas generator. In a known manner per se, the free turbine is completely independent of the gas generator, comprising one or two (high-pressure and low-pressure) compressors and one or two (high-pressure and low-pressure) turbines. Particularly, the shaft of the free turbine and the shaft of the gas generator (carrying the compressor(s) and the turbine(s)) are not connected. The free turbine is therefore distinct from the (high-pressure and low-pressure) turbine(s) carried by the shaft of the gas generator, which are connected to the compressor. Thus, the particularity of a free turbine turboprop lies in the separation of the “engine” (gas generator) and “power turbine” (or free turbine) elements. Furthermore, an aircraft generally comprises, in addition to this turbomachine, a reversible electric machine coupled to the gas generator, so as to rotate the gas generator during a start-up phase of the turbomachine, or in flight so as to ensure the non-propulsion electrical needs of the aircraft.

Traditionally, the gas generator includes at least one compressor and one turbine coupled in rotation. The operating principle is as follows: the fresh air entering the gas turbine is compressed due to the rotation of the compressor before being sent to a combustion chamber where it is mixed with a fuel. The burnt gases due to the combustion are then discharged at high speed. A first expansion then occurs in the gas generator turbine, during which the latter extracts the energy necessary to drive the compressor. The gas generator turbine does not absorb all the kinetic energy of the burnt gases and the excess kinetic energy corresponds to the gas stream generated by the gas generator. The latter therefore provides kinetic energy to the free turbine so that a second expansion occurs in the free turbine which transforms this kinetic energy into mechanical energy in order to drive a receiving member, such as a turboprop propeller.

During the start-up phase of the turbomachine, it is necessary to drive in rotation the gas generator, i.e. to drive in rotation the compressor coupled to the turbine. As mentioned above, this is precisely one of the roles of the reversible electric machine, known elsewhere, which is most often an electric motor able to operate reversibly as an electric generator.

Indeed, the aircrafts, in which such turbomachines are in particular intended to be integrated, include electrical equipment that must be powered by electric energy. The reversible electric machine is used to provide electricity to this electrical equipment. To do so, the electric machine, this time operating as an electric generator, is driven in rotation by the gas generator, the mechanical energy on the gas generator being transformed into electric energy by said machine. Moreover, the electric machine can be used to achieve internal hybridization, for example by delivering additional power to the propeller shaft or the engine shaft, or by generating power by a drawing operation from the free turbine shaft without affecting the performance of the gas generator.

To ensure these functions, the electric machine(s) must be dimensioned to a power much higher than that of the generators/starters usually used, typically one or several hundred kilowatts, instead of around ten kilowatts. It is therefore desirable to pool the two types of electric machines (the generator/starter of the turbine and the electric machine connected to the rotor).

However, existing architectures do not allow some functions to be performed by the electric machines. Moreover, these high-power electric machines involve difficulties in terms of bulk. For example, some turboprop architectures are characterized by a rear engagement at the level of the free turbines and of the hot gas ejection nozzles, to drive the reducer and the propeller of the turboprop, and by an accessory box in the cold part opposite to the engine to drive the equipment.

It is nevertheless difficult to integrate a high-power electric machine that is necessarily bulky on such architecture. Indeed, the installation in the hot part, under the nozzle, of an electric machine driven at high speed by the turbines, would present difficulties in terms of integration, maintainability and thermal environment. The only possible solution is therefore to drive the electric machine in the cold part, in particular at the level of the accessory box, and therefore to impact the performance of the gas turbine during the drawing operation from the gas generator. This contributes to significantly increasing the consumption of the engine. Moreover, this increased consumption impacts the endurance of the plane, which is nevertheless significant in a drone-type application for example.

Other types of architectures exist, in particular when the accessory box and the mechanical reducer of the propeller are both on the same side of the engine, by placing the electric machine in the cold area in the vicinity of the propeller cone. However, these architectures involve increasing the frontal section of the turbomachine, by offsetting the axis of the propeller relative to the main axis of the engine via a mechanical reducer, and/or involve impacting its centering, and limit the possibilities of pooling of the functions between the generator/starter of the turbine and the high-power electric machine.

There is therefore a need for an architecture that meets at least part of the drawbacks mentioned above.

### DISCLOSURE OF THE INVENTION

The present disclosure relates to a turbomachine for a hybrid aircraft, comprising a gas generator carried by a generator shaft, at least one free turbine carried by a turbine shaft and driven in rotation by a gas stream generated by the gas generator, a main rotor, and at least one reversible electric machine, the turbine shaft being a through shaft and extending axially between a first end engaged with the electric machine, and a second end engaged with the main rotor.

The turbomachine can be a turbine engine or a turboprop. In the remainder of the description, reference will preferably be made to a turboprop. The main rotor can be an aircraft, in particular airplane, propeller allowing its propulsion, the propeller then being disposed at one end of the turboprop, preferably at the front end of the turboprop when considering a normal direction of displacement of the aircraft. The main rotor is thus movable about an axis of rotation, preferably corresponding to the main axis of the turboprop.

By “through”, it is understood that the turbine shaft extends axially along the main axis of the turboprop, on either side of the latter. The turbine shaft thus passes through the high-pressure turbine, the combustion chamber and the compressor on one side, and the outlet nozzle on the other side. The turbine shaft thus passes through the thermally cold part comprising the air inlet and the compressor, and the thermally hot part, in other words where the temperatures are higher than in the cold part, and comprising the combustion chamber and the nozzle. The rotors of this turboprop are in particular configured so that the turbine shaft passes therethrough. Furthermore, preferably, the generator shaft and the turbine shaft are concentric, the turbine shaft passing through the gas generator by passing inside the generator shaft. It is thus understood that the turbine shaft is completely independent of the generator shaft and of the compressor(s) it carries.

Moreover, by “engaged with”, it is understood that the first end of the turbine shaft is mechanically connected to the electric machine, directly or indirectly. Thus, the reversible electric machine can drive in rotation the turbine shaft, and can conversely be driven by the turbine shaft to generate electricity. Similarly, it is understood that the second end of the turbine shaft is mechanically connected to the main rotor, for example to the propeller, directly or via a mechanical reducer.

Unlike the configurations in which the electric machine is disposed at the level of the accessory box in the cold part, by drawing energy from the generator shaft, this architecture comprising a through turbine shaft allows the electric machine, engaged with the turbine shaft, to draw energy from the latter, and thus limit the impact on the performance of the gas turbine and on the consumption of the engine.

Moreover, according to this architecture in which the through turbine shaft is engaged at its two ends, in particular at its first end with the electric machine and at its second end with the main rotor, it is possible to perform a large number of functions, while preferably maintaining an aligned arrangement along the same axis of the different components of the turboprop, and thus limiting the frontal section of the turboprop. This configuration makes it possible in particular to reduce the drag of the turboprop.

In some embodiments, the gas generator comprises a compressor and an air inlet configured to supply the compressor with fresh air, the first end of the turbine shaft engaged with the electric machine being disposed adjacent to the air inlet.

In other words, the electric machine is disposed in the thermally cold part of the turboprop. It is thus possible to facilitate the integration of the electric machine in the turboprop and to improve its maintainability, unlike warmer thermal environments such as under the hot gas ejection nozzle, on the side of the turbine.

In some embodiments, the second end of the turbine shaft is engaged with the main rotor via a mechanical reducer disposed between the free turbine and the main rotor.

Unlike an application on a helicopter turbine engine, in which the mechanical reducer and the electric machine are each disposed on the same side of the gas generator, the mechanical reducer and the electric machine are here disposed at opposite ends of the turbine shaft. Thus, the electric machine is disposed at the level of first end of the turbine shaft, preferably in the cold part, while the mechanical reducer can be disposed at the level of the second end of the turbine shaft, in the hot part. This makes it possible to maintain the electric machine in a cold thermal environment in order to improve its reliability, to improve the modularity for maintenance, to limit the frontal section of the hybrid turbomachine for improving the aerodynamics of the plane, and to limit the impact of the centering of the electric machine.

In some embodiments, the turbomachine comprises a combustion chamber, the second end of the turbine shaft being engaged with the main rotor downstream of the combustion chamber.

It is understood that the terms “upstream” and “downstream” are defined relative to the normal direction of flow of the gases in the turbomachine. In other words, the engagement between the second end of the turbine shaft and the main rotor is located in the thermally hot part of the turbomachine, after the gases have passed into the combustion chamber.

In some embodiments, the second end of the turbine shaft is engaged with the main rotor in the vicinity of the combustion chamber and of a hot gas ejection nozzle. Preferably, the engagement between the second end of the turbine shaft and the main rotor is located facing the ejection nozzle.

In some embodiments, the electric machine is in direct engagement with the first end of the turbine shaft, so as to rotate at the same speed as the turbine shaft.

The electric machine, for example with high power density, tends to rotate at speeds comparable to the free turbines, and can for example be fixed directly to the first end of the turbine shaft. This makes it possible to limit the number of assembly pieces required, and thus to simplify the architecture of the turboprop.

In some embodiments, the electric machine is engaged with the first end of the turbine shaft via a speed adaptation reducer.

When the free turbine does not allow direct engagement drive of the electric machine, depending on the dimensioning of the latter, the speed adaptation reducer makes it possible to adapt the rotational speed of the electric machine to that of the free turbine. This makes it possible to dissociate the optimum dimensioning of the free turbine and that of the electric machine.

In some embodiments, the electric machine is able to be coupled to the generator shaft so as to rotate the gas generator during a start-up phase of the turbomachine, and is able to be coupled to the turbine shaft after the start-up phase in order to generate electric power.

This configuration makes it possible to start the gas turbine by injecting power into the gas generator using the electric machine, then, when the speed of the gas generator exceeds a predetermined threshold, the turbine shaft then drives the electric machine so that the latter generates electric power. It is thus possible to achieve high power generation by a drawing operation from the turbine shaft without penalizing the performance of the gas turbine. This configuration is particularly advantageous for the non-hybrid applications requiring high electric generation, such as in the applications using drones for example.

In some embodiments, the electric machine is coupled to the generator shaft via a first freewheel configured to transmit a rotational torque from the electric machine, and is coupled to the turbine shaft via a second freewheel configured to transmit rotational torque to the electric machine.

It is understood that the first freewheel and the second freewheel are mounted in opposition. By “mounted in opposition”, it is understood that the first freewheel can transmit a rotational torque coming from the electric machine, but not vice versa, while the second freewheel can transmit a rotational torque to the electric machine, but not vice versa. Preferably, the electric machine is coupled to the generator shaft via the first freewheel and a first speed adaptation reducer, and is coupled to the turbine shaft via the second freewheel and a second speed adaptation reducer, the reduction ratios of the first and second speed adaptation reducers being determined such that after the starting of the gas generator, the first freewheel is desynchronized and the second freewheel is synchronized.

The freewheels have the advantage of not requiring to be electronically or mechanically controlled by an external operator. The freewheel also has significant reliability. Such a freewheel is generally made up of a hub and a peripheral ring rotatably mounted on the hub. The hub can generally drive in rotation the peripheral ring but not vice versa. It should be noted that in some cases, the freewheel is disposed such that the peripheral ring can drive in rotation the hub, but not vice versa, without questioning the principle of the present invention. Also, the hub can drive the ring only when the hub rotates in a predetermined direction relative to the ring, which will be called “engagement direction”. Otherwise, the hub and the peripheral ring rotate freely relative to each other.

In some embodiments, the electric machine is a first reversible electric machine, the turbomachine further comprising a second reversible electric machine engaged with the generator shaft, and able to exchange electric power with the first reversible electric machine.

The first electric machine engaged with the first end of the turbine shaft is then preferably a high-power electric machine, of the order of one or several hundred kilowatts, while the second electric machine is preferably of low power, of the order of 10 kW, such as a commonly used generator/starter.

According to this configuration, while the second electric machine is used for starting the gas turbine, the first electric machine can be used with the generator/starter to perform internal hybridization, i.e. an exchange of power between the electric machines to limit the aging of the gas turbine, by exchanging power between the body of the gas generator and the free turbine. This configuration also makes it possible to perform all of the desired functions, in particular assistance by power transfer to the turbine shaft or to the generator shaft in some transient phases, assistance to the gas turbine during takeoff, or generation of electricity in flight to recharge the batteries.

In some embodiments, the first electric machine is configured to operate in generator mode, in which it is able to be driven in rotation by the turbine shaft so as to generate electric power, or in motor mode in which it is able to deliver power to the turbine shaft.

In other words, in motor mode, the first electric machine is able to deliver power to the propeller in the case of a turboprop, or to the power take-off in the case of a turbine engine. The first electric machine can thus generate electric power without drawing power from the gas generator, which makes it possible to improve the specific consumption of the gas turbine. In addition, the motor mode allows power delivery to the turbine shaft, in some flight phases requiring it, such as takeoff, transient phases or maneuvers.

In some embodiments, the second electric machine is able to be coupled to the generator shaft via a first deactivatable coupling means, and to be coupled to the turbine shaft via a second deactivatable coupling means.

In some embodiments, at least one of the first and second deactivatable coupling means is a freewheel, preferably a blockable freewheel, the first deactivatable coupling means being configured to be activated when the second electric machine rotates in a first direction of rotation, and the second deactivatable coupling means being configured to be activated when the second electric machine rotates in a second direction of rotation opposite to the first direction of rotation.

By “deactivatable coupling means”, it is meant that the coupling means can be in an activated position in which the members connected to said coupling means are coupled, or in a deactivated position in which said members are decoupled, it being understood that by “member” is meant the electric machines, the main rotor, the gas generator and the free turbine. The deactivatable coupling means can in particular comprise a freewheel.

Given this configuration, it is possible to achieve a large number of functions, and in particular internal hybridization. More specifically, the second electric machine can ensure the drawing operation from the free turbine, for example by blocking the second deactivatable coupling means, so as not to affect the performance of the gas generator, or the injection of power on the turbine shaft, and therefore on the main rotor so as to assist the latter in some operating phases.

Furthermore, the second electric machine can be used in one direction of rotation to be mechanically coupled to the gas generator, and in the other direction of rotation to be mechanically coupled to the turbine shaft and therefore to the main rotor. Particularly, the second electric machine rotating in the first direction of rotation allows the coupling with the gas generator in order to start the latter on the ground, but also in order to supplement the thermodynamic power in some flight phases, for assistance with the transient phases or modification of the engine operating point for example.

The second electric machine rotating in the first direction of rotation also makes it possible to restart the gas generator in flight, for example following a failure thereof, without requiring the activation of another mechanical member such as a clutch. Moreover, the second electric machine rotating in the second direction of rotation makes it possible to drive the main rotor in some flight phases requiring an additional power delivery.

Consequently, the architecture according to the present disclosure has the advantage of being simple by limiting the number of components and connections, while making it possible to perform a large number of functions, in particular internal hybridization, and thus to improve the reliability of the device.

In some embodiments, the turbomachine comprises a rotor brake movable between a braking position, preventing the rotation of the main rotor, and a free position allowing the rotation of the main rotor, the rotor brake being disposed upstream of the gas generator. In other words, the propeller braking system is disposed not on the side of the propeller reducer, but opposite to the turbomachine, in the cold part thereof. It should be noted that the rotor brake function can be ensured by a blockable freewheel.

The present disclosure also relates to a hybrid aircraft comprising a turbomachine according to any one of the previous embodiments. The hybrid aircraft can be an airplane, and the turbomachine can be a turboprop.

It is meant by “hybrid aircraft” an aircraft comprising a heat engine for driving in rotation a main rotor, and at least one electric machine for delivering power to the heat engine.

### BRIEF DESCRIPTION OF THE DRAWINGS

The invention and its advantages will be better understood upon reading the detailed description given below of different embodiments of the invention given as non-limiting examples. This description refers to the appended pages of figures, on which:

FIG. 1 represents a cross-sectional view of a turboprop for a hybrid aircraft according to the invention,

FIG. 2 schematically represents the turboprop of FIG. 1 according to a first embodiment,

FIG. 3 represents the propulsion assembly of FIG. 1, according to a second embodiment,

FIG. 4 represents the propulsion assembly of FIG. 1, according to a first operating mode of the second embodiment,

FIG. 5 represents the propulsion assembly of FIG. 1, according to a second operating mode of the second embodiment,

FIG. 6 represents the propulsion assembly of FIG. 1, according to a third embodiment,

FIG. 7 represents the propulsion assembly of FIG. 1, according to a fourth embodiment,

FIG. 8 represents the propulsion assembly of FIG. 1, according to a fifth embodiment.

### DESCRIPTION OF THE EMBODIMENTS

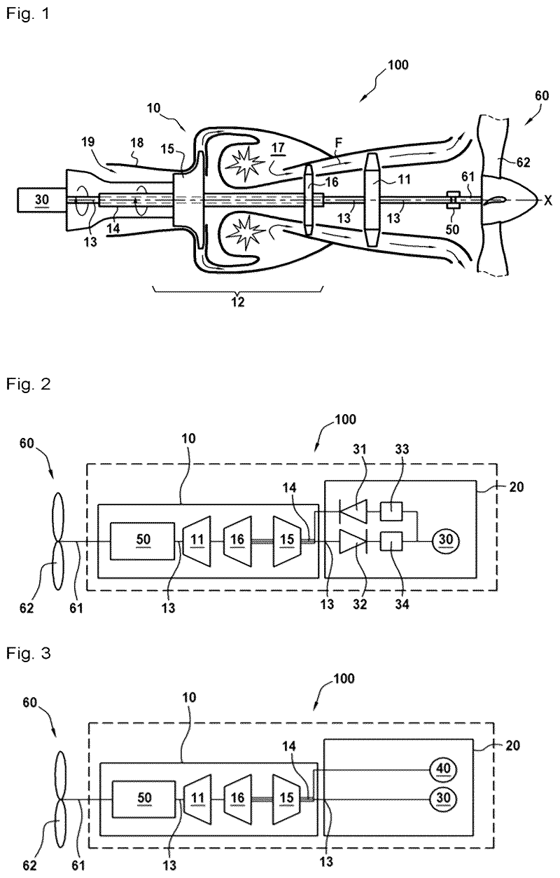

An architecture of a turbomachine, in this example of a turboprop 100 according to different embodiments of the invention will be described in the remainder of the description, with reference to FIGS. 1 to 8.

FIG. 1 schematically represents a turboprop 100 of an aircraft, driving in rotation the main rotor 60 of an airplane comprising a rotor axis 61 carrying a propeller 62.

The turboprop 100 is of the free turbine type, and comprises in this regard a gas turbine 10 having a gas generator 12 and a free turbine 11 able to be driven in rotation by a gas stream generated by the gas generator 12. The free turbine 11 is mounted on a turbine shaft 13 which transmits the rotational movement to the main rotor 60 via a mechanical reducer 50. Thus, the turbine shaft 13 is a through shaft, and extends between a first end conventionally called rear end (on the left in FIG. 1), and a second end conventionally called front end (on the right in FIG. 1), passing through the gas generator 12 and the free turbine 11.

The first end of the turbine shaft 13 is engaged with a reversible electric machine 30, and the second end of the turbine shaft 13 is engaged with the mechanical reducer 50. Thus, according to the invention, the gas turbine 10 is of the type with both front and rear power take-off.

The gas generator 12 includes a rotating generator shaft 14 on which are mounted at least one centrifugal compressor 15 and at least one turbine 16, as well as a combustion chamber 17 disposed axially between the compressor 15 and the turbine 16 when the gas generator 12 is considered along the axial direction of the generator shaft 14. The gas turbine 10 has a casing 18 provided with an air inlet 19 through which fresh air enters the gas generator 12. After its intake into the enclosure of the gas generator 12, the fresh air is compressed by the compressor 15 which drives it back towards the inlet of the combustion chamber 17 in which it is mixed with fuel. The combustion that takes place in the combustion chamber 17 causes the discharge of the burnt gases at high speed towards the turbine 16, which has the effect of driving in rotation the shaft 14 of the gas generator 12 and, consequently, the compressor 15. The rotational speed of the shaft 14 of the gas generator 12 is determined by the fuel flow rate entering the combustion chamber 17. Since the turboprop 100 is of the free turbine type, it will therefore be understood that the generator shaft 14 is independent of the turbine shaft 13. In other words, the free turbine 11 and the turbine shaft 13 are completely independent of the generator shaft 14 and of the compressor 15, unlike the turbine 16 which is connected to the compressor 15.

Despite the extraction of kinetic energy by the turbine 16, the gas stream leaving the gas generator has significant kinetic energy. As understood from FIG. 1, the gas stream F is directed towards the free turbine 11, which has the effect of causing an expansion in the free turbine 11 leading to the rotation of the turbine wheel and of the turbine shaft 13.

The reversible electric machine 30, including an electric motor able to operate reversibly as an electric generator, is disposed at the end of the shaft, engaged with the first end of the turbine shaft 13, such that it can deliver power to the turbine shaft 13 by operating in motor mode, or draw mechanical power from the turbine shaft 13 by operating in generator mode. In addition, the electric machine 30, disposed at the rear end of the turboprop 100, is thus located in a thermally cold part thereof, in particular adjacent to the fresh air inlet 19 of the gas generator 12.

It is understood that the thermally cold part of the turboprop 100 corresponds to the upstream part thereof in the direction of flow of the gas stream F, in particular upstream of the combustion chamber 17, and the thermally hot part of the turboprop 100 corresponds to the downstream part thereof, in particular at the level of the combustion chamber 17 and of the hot gas ejection nozzle F.

This arrangement of the electric machine 30 is advantageous given the significant bulk involved by the high-power electric machine 30 (one to several hundred kilowatts), and also given the difficulties of integration of such equipment related to the thermal constraints in the hot part of the turboprop 100.

Moreover, given this architecture, all of the equipment, in particular the electric machine 30, the gas generator 12, the free turbine 11, the mechanical reducer 50 and the main rotor 60, are all coaxial and centered on the same main axis X. This architecture makes it possible to limit the frontal section of the turboprop 100, while allowing a large number of functions to be performed, depending on the applications envisaged. These different functions are described below with reference to FIGS. 2 to 8.

It will be noted in general that, for the sake of clarity, FIGS. 2 to 8 schematically represent in a functional and simplified manner the different operating modes of the device, without representing all the details of the elements constituting the turboprop and the different power transmission members. Particularly, the pinions and possible speed ratios are not represented.

FIG. 2 schematically represents the turboprop 100 of FIG. 1, in an inverted orientation, the propeller 62 being oriented towards the left in this figure. The rear part of the turboprop 100, in other words the thermally cold part, comprises an accessory gearbox 20, known by the acronym “AGB”. This gearbox in particular comprises the reversible electric machine 30, and different equipment, depending on the chosen application.

Particularly, FIG. 2 represents an operating mode allowing the switching between the gas generator 12 and the free turbine 11. More specifically, the reversible electric machine 30 is mechanically coupled to the generator shaft 14 of the gas generator 12 by first deactivatable coupling means, comprising a first freewheel 31 and, preferably, a first speed adaptation reducer 33 disposed between the electric machine 30 and the first freewheel 31.

The first freewheel 31 is mounted such that the rotation of the reversible electric machine 30 can drive in rotation the generator shaft 14 when the reversible electric machine 30 operates as an electric motor (first coupling means activated) but that, on the contrary, the rotation of the generator shaft 14 cannot drive in rotation the reversible electric machine 30 (first coupling means deactivated). In other words, the first freewheel 31 can transfer a rotational torque only in the direction of the reversible electric machine 30 towards the gas generator 12, and not vice versa. Thus, the rotation of the reversible electric machine 30 is able to drive in rotation the shaft 14 of the gas generator 12 in order to start the latter. When the gas generator 12 has started, the reversible electric machine 30 no longer drives in rotation the gas generator 12.

According to the invention, the reversible electric machine 30 is also able to be coupled to the turbine shaft 13 of the free turbine 11, advantageously by means of second coupling means, in such a way that said reversible electric machine 30, operating as an electric generator, is able to be driven in rotation by the free turbine 11 in order to provide electricity. The second coupling means comprise a second freewheel 32, similar to the first freewheel 31, and a second speed adaptation reducer 34 disposed between the second freewheel 32 and the electric machine 30. This second speed adaptation reducer 34 has a reduction coefficient chosen in such a way that the speed of the reversible electric machine 30 is adapted to the speed range required to allow the supply of electricity. The second freewheel 32 is indeed mounted such that it can transmit a rotational torque only from the shaft 13 of the free turbine 11 to the electric machine 30.

In other words, thanks to the second freewheel 32, the reversible electric machine 30 can be driven by the free turbine 11 (second coupling means activated) but cannot drive in rotation the latter (second coupling means deactivated). When the free turbine 11 drives in rotation the reversible electric machine 30, the latter operates as an electric generator and produces electricity.

The first and second freewheels 31, 32 are mounted in opposition. In this case, they have opposite directions of engagement. Thus, when the reversible electric machine 30, operating as a motor, drives in rotation the shaft 14 of the gas generator 12 (first freewheel 31 engaged, i.e. first coupling means activated), the second freewheel 32 does not transmit the rotational torque of the reversible electric machine 30 to the shaft 13 of the free turbine 11 (second coupling means deactivated). Conversely, when the shaft 13 of the free turbine 11 drives in rotation the reversible electric machine 30 operating as an electric generator (second freewheel 32 engaged, i.e. second coupling means activated), the first freewheel 31 does not transmit the rotational torque of the reversible electric machine 30 to the shaft 14 of the gas generator 12 (first coupling means deactivated).

In this case, the gearbox 20 comprises the reversible electric machine 30, the freewheels 31, 32 and the speed adaptation reducers 33, 34. It will be noted that a similar function is detailed in document FR2929324 applied to a turbine engine, in which the electric machine and the mechanical reducer are disposed on the same side of the turbine engine, unlike the present invention where the electric machine 30 and the mechanical reducer 50 are disposed at opposite ends of the turboprop 100.

FIG. 3 represents an operating mode in which two reversible electric machines are used, as a replacement for the freewheels 31 and 32. In this case, the gearbox 20 comprises the reversible electric machine 30, which is a first electric machine, and further comprises a second reversible electric machine 40 coupled to the generator shaft 14. While the first electric machine 30 is a high-power electric machine, in particular several hundred kilowatts, the second electric machine 40 can be a commonly used starter, with a power of the order of 10 kW.

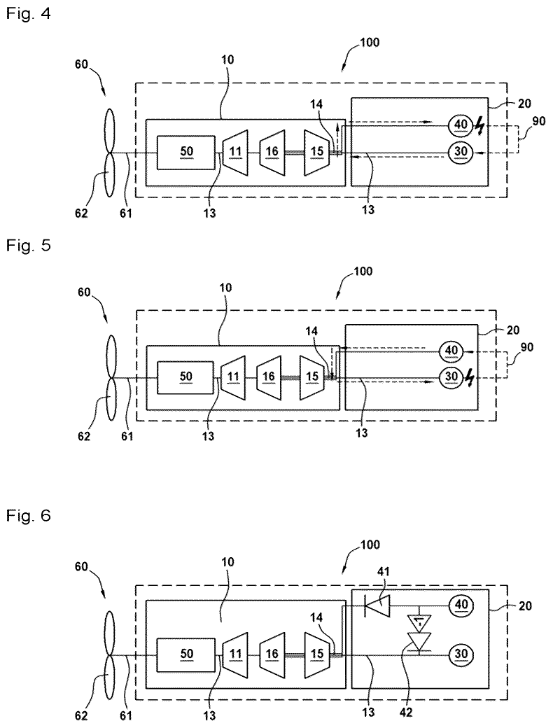

This configuration makes it possible to perform a large number of functions, in particular assistance by power transfer to the turbine shaft 13 or to the generator shaft 14 in some transient phases or assistance to the gas turbine 10 during takeoff by drawing power from a battery pack, or generation of electricity in flight to recharge the batteries. Moreover, the transfer of power between the two electric machines also makes it possible to change the operating point of the turbomachine advantageously by the internal hybridization. FIGS. 4 and 5 illustrate examples of these functions.

In FIGS. 4 and 5, the arrows in broken lines represent a direction of transmission of mechanical or electric power between two elements. In FIG. 4 for example, mechanical power is transmitted from the first electric machine 30 to the turbine shaft 13, and from the generator shaft 14 to the second electric machine 40, and electric power is transmitted from the second electric machine 40 to the first electric machine 30.

FIG. 4 represents for example a mode of assistance of the gas generator 12 towards the turbine shaft 13. In this case, while the first electric machine 30 operates in motor mode by delivering power to the turbine shaft 13, for example to assist the gas turbine during takeoff, the second electric machine 40 operates in generator mode by drawing power from the generator shaft 14, and by transferring electric power to the first electric machine 30 via an electrical connection 90, so as to assist the first electric machine 30. The “generator” mode is represented by a small lightning in FIG. 4 and FIG. 5.

FIG. 5 represents conversely a mode of assistance of the turbine shaft 13 towards the gas generator 12. In this case, while the second electric machine 40 operates in motor mode by delivering power to the generator shaft 14, the first electric machine 30 operates in generator mode by drawing power from the turbine shaft 13, and by transferring electric power to the second electric machine 40 via the electrical connection 90, so as to modify the operating point of the gas generator for example.

Alternatively, the second electric machine 40 may have a higher power, for example equivalent to that of the first electric machine 30. This operating mode is represented in FIG. 6, in which the second electric machine 40 is mechanically coupled to the shaft 14 of the gas generator 12 by means of a first deactivatable coupling means, and is mechanically coupled to the turbine shaft 13 by means of a second deactivatable coupling means.

The first deactivatable coupling means can in particular comprise a first freewheel 41 mounted such that the rotation of the second reversible electric machine 40 can drive in rotation the shaft 14 of the gas generator 12 when the second electric machine operates in electric motor mode, but when on the contrary, the rotation of the shaft 14 of the gas generator 12 cannot drive the second reversible electric machine 40, if the first freewheel 41 is not blocked. In other words, the first freewheel 41 can transfer a rotational torque only in the direction of the second electric machine 40 towards the gas generator 12, but not vice versa.

However, if the first freewheel 41 is a blockable wheel, the blocking of this wheel then allows the generator shaft 14 to drive the second electric machine 40 so that it operates in generator mode for “APU” modes with the rotor stopped for example, the “APU” (Auxiliary Power Unit) mode being an operating mode where the gas turbine drives an electric generator without driving the main rotor, to ensure the supply of the electric devices on the ground, such as batteries, flight equipment, heating or air conditioning.

The second deactivatable coupling means can in particular comprise a second freewheel 42, such that the second electric machine 40, operating in motor mode, is able to drive in rotation the turbine shaft 13.

The second reversible electric machine 40 is able to rotate in a first direction of rotation (by convention, a positive direction) in which it is mechanically coupled to the shaft 14 of the gas generator 12 via the first freewheel 41, and in a second direction of rotation (by convention, a negative direction), opposite to the first direction of rotation, in which it is mechanically coupled to the turbine shaft 13 via the second freewheel 42.

Particularly, the element represented by “−1” in FIG. 6 and the following figures represents gears, for example pinions, allowing the reversal of the direction of rotation. It will thus be understood that when the second electric machine 40 rotates in the positive direction, the first deactivatable coupling means is activated, and the second coupling means is deactivated, and when the second electric machine 40 rotates in the negative direction, the first deactivatable coupling means is deactivated, and the second coupling means is activated.

The second reversible electric machine 40 is constituted in this case by an electric motor able to operate reversibly as an electric generator. To do so, either of the first freewheel 41 or of the second freewheel 42 can be blocked, by means of a blocking means, so as to be able to be driven in rotation by the main rotor 60 or by the gas generator 12, and thus generate electric power. This electric power generated by the second electric machine 40 can then be transferred to other elements of the turboprop 100, for example to a “battery pack” (not represented) or can be exchanged between the electric machines 30, 40 to achieve internal hybridization.

Particularly, according to this configuration, it is possible to perform a certain number of functions. For example, the second electric machine 40 can be used to perform a rapid starting of the gas turbine 10 by rotating in the positive direction, and also to inject power onto the turbine shaft 13 by rotating in the negative direction, in particular in the climb phase, so as to supplement the power delivered by the first electric machine 30.

Furthermore, when the gas generator 12 operates autonomously and is no longer driven by the second electric machine 40, the first electric machine 30 can operate in electric generator mode by being driven by the turbine shaft 13. The electric power thus generated by the first electric machine 30 can be used to power the on-board electrical accessories or charge the battery.

The first electric machine 30 and the second electric machine 40 can also deliver power to the main rotor 60 by both operating in electric motor mode. The second electric machine 40 then rotates in the negative direction. This configuration can be useful in some flight phases requiring an additional power delivery, for example during takeoff. The first electric machine 30 and the second electric machine 40 thus make it possible to supplement the power delivered to the main rotor 60 by the free turbine 11.

Moreover, the first electric machine 30 can operate in electric generator mode and allow a power delivery to the gas generator 12 via the second electric machine 40 then rotating in the positive direction. This configuration can be useful in some flight phases, for example for assistance to the gas generator during rapid accelerations, or for modifying the engine operating point in “high altitude—hot weather” flight use conditions”.

It is also possible to deliver power to both the main rotor 60 by the first electric machine 30, and to the gas generator 12 by the second electric machine 40, each operating in electric motor mode. The second electric machine 40 then rotates in the positive direction. This in particular allows assistance with fast transients, in which the first electric machine 30 assists the main rotor 60 to limit the drop in revolutions, while the second electric machine 40 assists the gas generator 12 to improve the power availability time on the free turbine 11.

A restarting of the gas turbine 10 in flight, in the event of its shutdown, is also possible. Immediately after the detection of the shutdown of the turboprop, the first electric machine 30 operates in electric motor mode to provide emergency power to the main rotor 60. The speed of the gas generator 12 then decreases to an ignition window, allowing the restarting of the turboprop. Meanwhile, the second electric machine 40 can advantageously be rotated in the positive direction at a speed slightly lower than the re-ignition speed. This saves time and facilitates the resynchronization of the second freewheel 42. When the ignition window is reached, the second electric machine 40 rotating in the positive direction then drives the gas generator 12 via the first freewheel 41, making it possible to restart the gas turbine 10.

This architecture is particularly advantageous in that it allows, with only two electric machines, providing power to the main rotor 60, by the first electric machine 30 and the second electric machine 40, while allowing the restarting of the gas turbine 10 by the second electric machine 40 in some operating phases and internal hybridization for the high and hot flights for example. It should also be noted that the various steps described above can be carried out by a monitoring unit (not represented), making it possible to detect the shutdown of the engine, the rotational speed of the shafts of the gas generator and of the free turbine, and to monitor the electric machines.

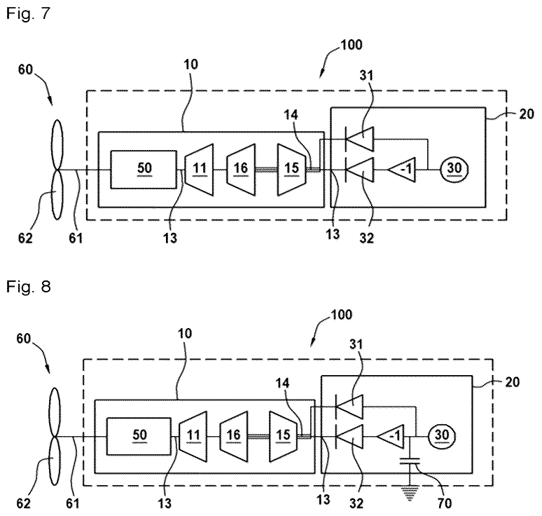

FIG. 7 represents an alternative example of architecture according to the invention, in which the gearbox 20 comprises a single reversible electric machine 30, driving in rotation the generator shaft 14 via a first freewheel 31 when it rotates in the positive direction, and driving the turbine shaft 13 via a second freewheel 32 when it rotates in the negative direction. This configuration makes it possible to perform most of the functions described above, except for internal hybridization. In this configuration, at least one of the two freewheels 31, 32 can be blocked to allow the electric generation function.

FIG. 8 represents an example of architecture similar to the example of FIG. 7, in which a rotor brake 70 is disposed between the electric machine 30 and the second freewheel 32. The rotor brake 70 is movable between a braking position, preventing the rotation of the propeller 62 and of the free turbine 11, and a free position allowing the rotation of the propeller 62 and of the free turbine 11. The rotor brake 70 therefore makes it possible to block the free turbine 11, and therefore the main rotor 60, in particular in the event of starting in strong winds. The presence of the through turbine shaft 13 makes it possible to position this rotor brake 70 in a thermally cold area, on the side of the first end of the turbine shaft 13, to the rear of the turboprop 100.

Although the present invention has been described with reference to specific exemplary embodiments, it is obvious that modifications and changes can be made to these examples without departing from the general scope of the invention as defined by the claims. Particularly, the use of the blockable or non-blockable freewheels can be replaced by any active coupling means such as dogs or clutches. Particularly, individual characteristics of the different embodiments illustrated/mentioned can be combined in additional embodiments. Consequently, the description and the drawings must be considered in an illustrative rather than restrictive sense.

1. A turbomachine for a hybrid aircraft, comprising a gas generator carried by a generator shaft, at least one free turbine carried by a turbine shaft and driven in rotation by a gas stream generated by the gas generator, a main rotor comprising a propeller, and at least one reversible electric machine, the turbine shaft being a through shaft extending axially between a first end engaged with the electric machine upstream of the gas generator, and a second end engaged with the main rotor downstream of the gas generator.

2. The turbomachine according to claim 1, wherein the gas generator comprises a compressor and an air inlet configured to supply the compressor with fresh air, the first end of the turbine shaft engaged with the electric machine being disposed adjacent to the air inlet.

3. The turbomachine according to claim 1, wherein the second end of the turbine shaft is engaged with the main rotor via a mechanical reducer disposed between the free turbine and the main rotor.

4. The turbomachine according to claim 1, comprising a combustion chamber, the second end of the turbine shaft being engaged with the main rotor downstream of the combustion chamber.

5. The turbomachine according to claim 1, wherein the electric machine is in direct engagement with the first end of the turbine shaft, so as to rotate at the same speed as the turbine shaft.

6. The turbomachine according to claim 1, wherein the electric machine is engaged with the first end of the turbine shaft via a speed adaptation reducer.

7. The turbomachine according to claim 1, wherein the electric machine is configured to be coupled to the generator shaft so as to rotate the gas generator during a start-up phase of the turbomachine, and is able configured to be coupled to the turbine shaft after the start-up phase in order to generate electric power.

8. The turbomachine according to claim 7, wherein the electric machine is coupled to the generator shaft via a first freewheel configured to transmit a rotational torque from the electric machine, and is coupled to the turbine shaft via a second freewheel configured to transmit a rotational torque to the electric machine.

9. The turbomachine according to claim 1, wherein the electric machine is a first reversible electric machine, the turbomachine further comprising a second reversible electric machine engaged with the generator shaft, and configured to exchange electric power with the first reversible electric machine.

10. The turbomachine according to claim 9, wherein the first electric machine is configured to operate in a generator mode to be driven in rotation by the turbine shaft so as to generate electric power, or in motor mode to deliver power to the turbine shaft.

11. The turbomachine according to claim 9, wherein the second electric machine is configured to be coupled to the generator shaft via a first deactivatable coupling means, and to be coupled to the turbine shaft via a second deactivatable coupling means.

12. The turbomachine according to claim 11, wherein at least one of the first and second deactivatable coupling means is a freewheel, the first deactivatable coupling means being configured to be activated when the second electric machine rotates in a first direction of rotation, and the second deactivatable coupling means being configured to be activated when the second electric machine rotates in a second direction of rotation opposite to the first direction of rotation.

13. The turbomachine according to claim 1, comprising a rotor brake movable between a braking position, preventing the rotation of the main rotor, and a free position allowing the rotation of the main rotor, the rotor brake being disposed upstream of the gas generator.

14. A hybrid aircraft comprising a turbomachine according to claim 1.
